(19) United States
(12) Patent Application Publication
(10) Pub. No.: US 2014/0352222 A1
(43) Pub. Date: Dec. 4, 2014

(54) Module Unit For Opening And Closing Of Wings

(71) Applicant: HUF HÜLSBECK & FÜRST GMBH & CO. KG, Velbert (DE)

(72) Inventor: Ralf Lennhoff, Hagen (DE)

(73) Assignee: HUF HÜLSBECK & FÜRST GMBH & CO. KG, Velbert (DE)

(21) Appl. No.: 14/271,507

(22) Filed: May 7, 2014

(30) Foreign Application Priority Data
May 29, 2013 (DE) 10 2013 009 112.8

(51) Int. Cl. E05F 11/54; E05B 77/14; E05B 85/00; B60J 5/00

(52) U.S. Cl. CPC E05F 11/54; B60J 5/00; E05B 77/14; E05B 85/00
USPC 49/324

(57) ABSTRACT

A modular unit for opening and closing doors, in particular of motor vehicles, includes a first module which has at least one actuating unit and a second module which has at least one lock assembly. The first module and the second module are coupled together via a coupling member in order to actuate a lock of the lock assembly when the first module, in particular the actuating unit, is actuated in order to initiate the opening and/or closing procedure of the door. A connecting element is arranged between the first module and the second module. The connecting element maintains the distance between the modules relative to one another substantially constant when a force F acts on at least one of the modules.

### CROSS-REFERENCE TO RELATED APPLICATIONS

The present application claims the benefit of German Patent Application No. 10 2013 009 112.8 filed May 29, 2013, which is fully incorporated herein by reference.

### STATEMENT REGARDING FEDERALLY SPONSORED RESEARCH OR DEVELOPMENT

Not applicable.

### FIELD OF THE INVENTION

The invention relates to a modular unit for opening and closing doors, in particular of motor vehicles, comprising a first module which has at least one actuating unit and a second module which has at least one lock assembly, wherein the first module and the second module are coupled together via a coupling member in order to actuate a lock of the lock assembly when the first module, in particular the actuating unit, is actuated in order to initiate the opening and/or closing procedure of the door.

### BACKGROUND OF THE INVENTION

Motor vehicles with doors configured as side doors or tail gates are known from the prior art. In order to open the side doors, for example, a user has to pull a door handle arranged on a carrier configured as a bearing bracket. If the door handle is pulled, the lock is actuated via a coupling element which connects the door handle and a lock so that the opening procedure is initiated. It has been shown that such modular units may be unreliable, in particular when an unauthorized user inserts a tool, in particular a screwdriver, into a gap between the window and door. The unauthorized user supports the screwdriver, for example, on the bearing bracket and by means of a further tool, in particular by means of a hammer, exerts a force on the screwdriver. Consequently, the bearing bracket is moved in the direction of the ground plane and, as a result, also the coupling element which is associated with the bearing bracket. The lock remains in an immobile state relative to the bearing bracket so that the coupling element, which is operatively connected to the lock, actuates the lock and thus initiates the opening procedure. As a result, the door is opened and the unauthorized user has clear access to the vehicle. Moreover, in the event of a crash of the motor vehicle in the worst case the lock assembly is displaced relative to the door handle, also potentially leading to inadvertent actuation of the lock by the coupling member.

### SUMMARY OF THE INVENTION

Thus the object of the invention is to improve the anti-theft protection and crash safety of a modular unit for opening and closing doors, using means which are of simple construction and cost-effective.

The object is achieved in that an additional connecting element is arranged between the first module and the second module, wherein by means of the connecting element the distance between the modules relative to one another remains substantially constant when a force F acts on at least one of the modules. If a thief inserts a tool, such as for example a screwdriver, into the gap between the door panel and the window, the thief is able to touch the first module with the tip of the screwdriver. In a subsequent step, the thief strikes the screwdriver with a hammer. In this case, a movement of the first module is not possible as the connecting element is supported on the second module. As a result, the coupling member which connects the lock assembly, in particular the lock, also remains in a substantially immobile state. In the case of no connecting element being present, the first module and the coupling member would move relative to the second module, wherein the second module could remain immobile in its position. The movement of the coupling member in this case leads to a release of the lock as the distance between the first module and the second module is altered. The connecting element advantageously prevents a relative movement from taking place between the first module and the second module, leading to an actuation of the lock by the coupling member. Depending on the construction, it is also conceivable for the thief to set the second module in motion by means of the tools and thus attempt to actuate the lock. In this case the second module is supported by means of the connecting element on the first module so that a relative movement of the two modules relative to one another is also substantially excluded.

Moreover, by means of the solution according to the invention in the event of a crash it is also ensured that by means of the additional connecting element the distance between the modules remains substantially constant, as the additional connecting element connects the two modules together in a fixed manner. In principle, in the event of a crash, in the worst case the second module, in particular the lock, may be set in motion. However, depending on the direction of the crash, the two modules are supported via the connecting element so that an actuation of the lock is excluded.

The security of the modular unit for opening and closing doors is markedly improved. Moreover, the modular unit according to the invention is characterized by a cost-effective and simple construction which may also be installed retrospectively when retrofitted in already existing modular units. A connection has to be provided by means of a connecting element between the first module and the second module.

According to a further preferred embodiment, it is provided that the first module comprises a carrier for receiving a locking cylinder and for mounting the actuating unit, in particular a door handle configured as an actuating unit. By means of the carrier, the actuating unit may be fastened to a door structure in a reliable and simple manner.

In order to increase the anti-theft protection further, it is provided that the carrier and/or the locking cylinder is surrounded at least partially by a covering element. Moreover, the carrier also serves to fasten the connecting element securely.

The construction is very simple and cost-effective when the connecting element is fastened to the carrier and/or to the covering element by a material connection and/or a positive connection and/or a non-positive connection.

In order to increase the anti-theft protection, it is provided that the connecting element connects together the first module and the second module. In particular, when the first module and the second module are arranged spaced apart from one another, the force acting on the one module may be transmitted to the other module.

The production process and the mounting of the modules are simplified if the connecting element is configured in one piece with the carrier or the covering element. Thus, an additional operating step which requires the fastening of the connecting element to one of the modules may be dispensed with. Consequently, the production process is faster and also more cost-effective as a result.

In order to simplify the mounting of the connecting element, it is provided that the carrier or the covering element has an opening in which the connecting element is arranged, in particular mounted.

In order to prevent a release of the lock in the event of the above-described theft, it is provided that the connecting element is fastened to the lock assembly, in particular to a housing of the lock. Thus, the force exerted on the first module acts directly on the lock housing so that an actuation of the lock is prevented. As a result, the thief is prevented from having access to the vehicle.

The connecting element may be securely mounted when the housing of the lock assembly has an opening which serves for receiving the connecting element. In this case, the connecting element is hooked or clipped, for example, into the opening. Thus the connecting element is prevented from being pulled off the lock assembly even by forces acting at the top of the connecting element.

The modular unit has a compact structural design if the connecting element is configured as a supporting bar. In this case it may be provided that the supporting bar is configured from metal, in particular stainless steel. The diameter of the cross section of the bar should be selected such that even in the case of high forces the supporting bar is prevented from being broken. It is also very advantageous if the diameter of the cross section of the supporting bar is configured to be the same as the diameter of the cross section of the coupling member. In this case, a single tool is sufficient in order to produce bars which may be shaped in a further operating process to form a supporting bar and to form a coupling member.

The modular unit is protected very securely from inadvertent opening by a thief or as a result of a crash if the coupling member is configured as a Bowden cable or a bar.

### BRIEF DESCRIPTION OF THE DRAWINGS

The invention is described in more detail with reference to the following description and the figures, in which:

FIG. 1a shows a modular unit according to the invention in a perspective view from the front according to a first exemplary embodiment,

FIG. 1b shows the modular unit according to the invention in a side view according to the first exemplary embodiment,

FIG. 1c shows a detail of the modular unit according to the invention in a view from the rear according to the first exemplary embodiment,

FIG. 2a shows a modular unit according to the invention in a perspective view from the front according to a second exemplary embodiment,

FIG. 2b shows the modular unit according to the invention in a side view according to the second exemplary embodiment, and

FIG. 2c shows a detail of a modular unit according to the invention in a view from the rear according to the second exemplary embodiment.

### DETAILED DESCRIPTION OF THE EXAMPLE EMBODIMENTS

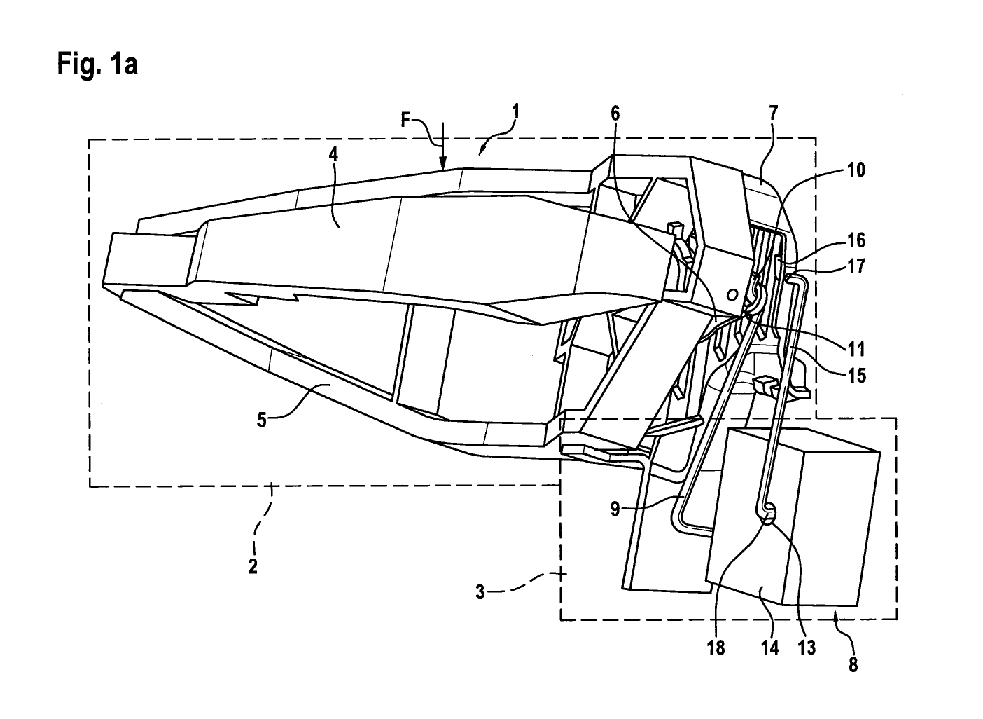

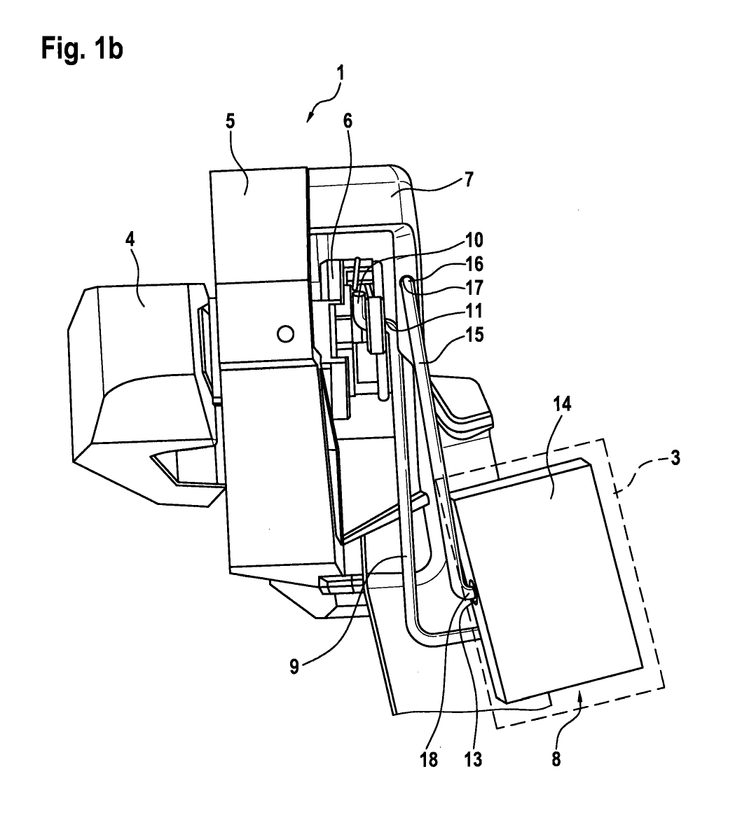

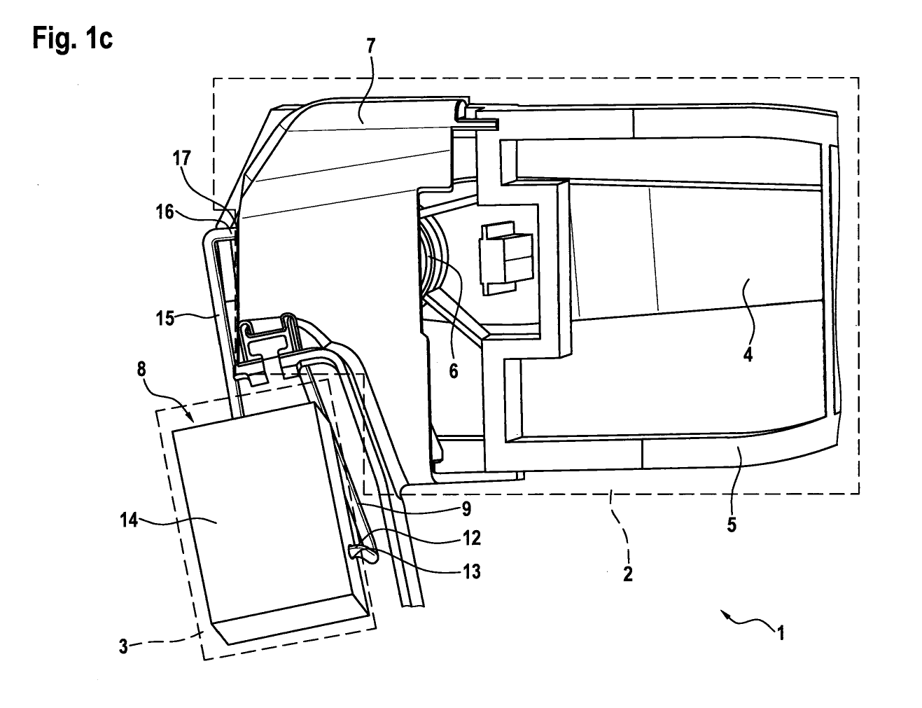

In FIGS. 1a, 1b and 1c a first embodiment of the modular unit 1 according to the invention for opening and closing doors is shown. The doors, not shown in more detail, are, amongst other things, doors or tail gates of motor vehicles. The modular unit 1 comprises a first module 2 and a second module 3. The first module 2 has at least one actuating unit 4 configured as a handle, in particular as a door handle, which may be pulled by a user in order to initiate the opening procedure. The actuating unit 4 is arranged on a bearing bracket configured as a carrier 5, said bearing bracket, for example, being able to be fastened to a bodywork panel of a door. The actuating unit 4 is connected to a lever 6 which, when the actuating unit 4 is actuated, is moved by means of a deflection lever, not illustrated further, which mechanically couples the actuating unit 4 to the lever 6. The lever 6 may also be set in motion via a locking cylinder which is able to be moved in a rotational manner, not shown in more detail. In this case, the locking cylinder is mechanically coupled to the lever 6. The locking cylinder, the lever 6 and the bearing bracket 5 are partially surrounded by a covering element 7.

The second module 3 comprises a lock assembly 9 having a lock, which is provided with at least one rotary latch not shown in more detail and a locking pawl. The first module 2 and the second module 3 are connected mechanically together by a coupling member 9 configured as a bar, or as a Bowden cable, wherein the coupling member 9 is fastened with its first end 10 in an eye configured as an opening 11 on the lever 6 and with its second end 12 is guided through an opening 13 of a housing 14 of the lock assembly 7 configured as a through-opening. Inside the housing 14 of the lock assembly 7, the coupling member 9 is mechanically coupled to components of the lock, in particular to the rotary latch. When actuating the handle, the lock is actuated via the coupling member 8 and the opening procedure is initiated.

According to the first exemplary embodiment, an additional connecting element 15 configured as a supporting bar is arranged between the first module 2 and the second module 3, wherein by means of the connecting element 15 the distance between the modules relative to one another when exerting a force F on at least one of the modules 2, 3 remains substantially constant. In this case, the connecting element 15 is positively connected to the covering element 7 by a first end 16 of the connecting element being hooked into an opening 17 of the covering element 7 configured as a through-opening or hole. It is also conceivable to connect the connecting element 15 to the covering element 7 by a material connection or non-positive connection. Accordingly, the covering element 7 has two functions. Firstly it ensures that the anti-theft protection is improved as the thief has to remove the covering element 7 for actuating the lever 6. Secondly it serves to fasten the additional connecting element 15 to the covering element 15. At the same time care should be taken that the connecting element 15 is arranged at a position of the covering element 7 which is inaccessible or only accessible with great difficulty to a thief due to the considerable amount of time required. This is the case, for example, when the connecting element 15 is fastened to the side on the covering element 7 as shown in FIGS. 1a and 1b.

The second end 18 of the connecting element 15 is positively connected to the housing 14 of the lock assembly 8 by being hooked into an opening 13 of the housing 14 of the lock assembly 8 configured as a through-opening. It is also possible to connect the second end 18 of the connecting element 15 by a non-positive connection or a material connection to the housing 14 of the lock assembly 8. Thus, for example, the connecting element 15 may be configured from a metal material which is then welded to a housing 14 of the lock assembly 8 configured from metal. As a result, the first module 2 and the second module 3 are fixedly connected together by means of the connecting element 15.

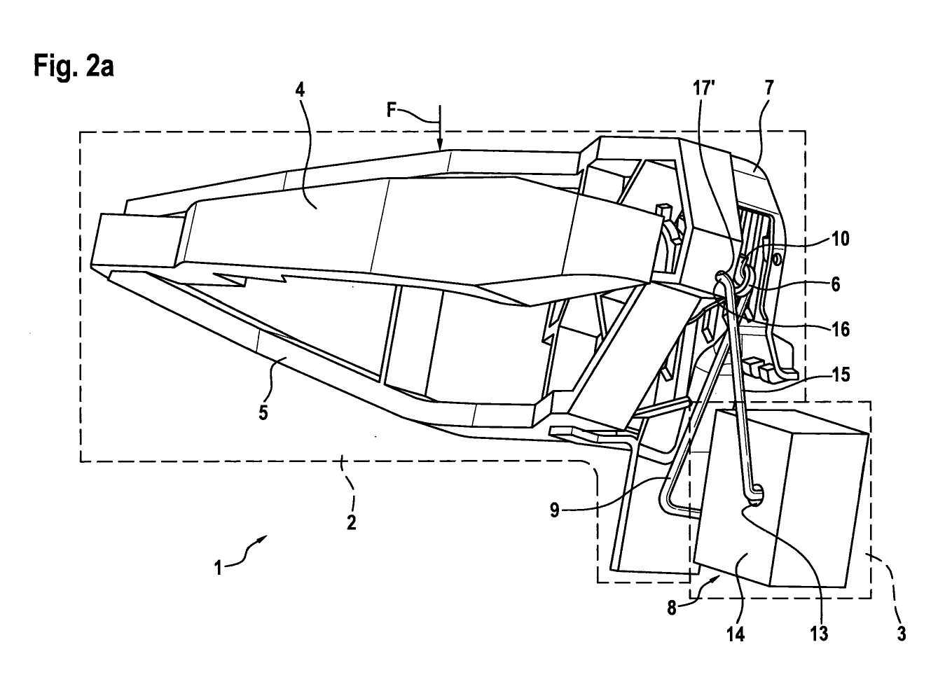

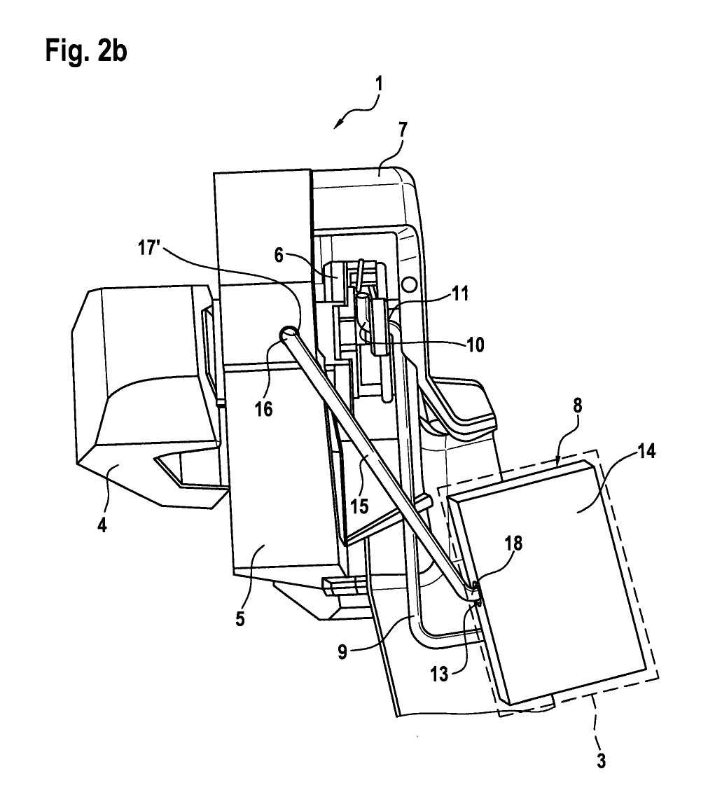

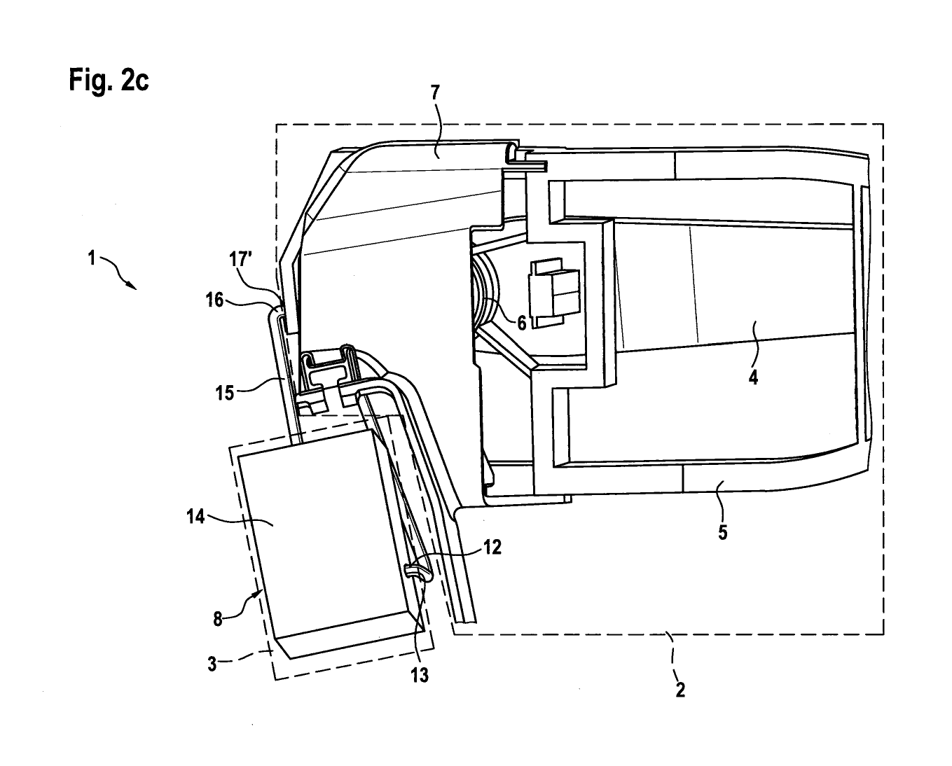

In FIGS. 2a to 2c, a second embodiment of the module unit 1 according to the invention is shown. The same reference numerals as in the first exemplary embodiment are used for components in the second exemplary embodiment which have already been described in the first exemplary embodiment. New components in the second exemplary embodiment are provided with new reference numerals.

The second embodiment differs from the first embodiment in that the connecting element 15 is positively connected to the carrier 5. In this case, the carrier has an opening 17′ configured as a through-hole, in which the first end 16 of the connecting element 15 is arranged, in particular hooked. In the second exemplary embodiment, the connecting element 15 may alternatively be connected by a material connection or a non-positive connection to the carrier 5. As already described in the first exemplary embodiment, in the second exemplary embodiment the connecting element 15 also has to be fastened at a position which is inaccessible to a thief. Therefore, the connecting element 15 is arranged at the side on the carrier 5.

The mode of operation of the connecting element 15 is described in more detail hereinafter. As already described above, the connecting element 15 acts to support the first module 2 on the second module 3. If a force F acts on the first module 2, the connecting element 15 prevents the first module 2 from moving toward the second module 3. The distance between the two modules 2, 3 remains substantially constant. Thus the coupling member 9 is prevented from moving and the lock from being inadvertently actuated in order to initiate the opening procedure of the door. The force F may, for example, be produced by a crash. Thus the connecting element 15 advantageously prevents the doors from opening in the event of a crash. The safety for occupants located in the vehicle is, therefore, considerably improved.

Additionally, the anti-theft protection is increased. If a thief wishes to gain access to the vehicle, an attempt could be made to set the carrier 5 in motion relative to the lock assembly 8 using a tool. By means of a screwdriver the thief gains access through a gap between the door panel and the window and is able to touch the first module 2, in particular the carrier 5 or the covering element 7, with the tip of the screwdriver. In a further step, the thief strikes the screwdriver with a hammer. In this case, a movement of the first module 2, in particular the carrier 5 and/or the covering element 7, is excluded as the first module 2 is supported by means of the connecting element 15 on the second module 3. As a result, the coupling member 9 which connects the lock assembly 8, in particular the lock, also remains in a substantially immobile state. A relative movement between the two modules 2, 3 is thus advantageously excluded by the connecting element 15.

Other embodiments are also possible. Thus, for example, the connecting element 15 may be configured in one piece with the carrier 5 or with the covering element 7. In this case the carrier 5 or the covering element 7 would be directly supported on the second module 3. Naturally, a plurality of connecting elements 15 could also be used in order to connect the two modules 2, 3 together. Thus, as a result, an embodiment is also possible which combines the teaching of the first and second exemplary embodiments. Thus, a first connecting element may connect the lock assembly 8 to the carrier 5 and a second connecting element may additionally connect the covering element 7 to the lock assembly 8. Thus, the support of the first module 2 on the second module 3 is further improved and/or stabilized so that even greater forces are able to act on the first module 2 and/or second module 3.

1. A Modular unit for opening and closing doors of motor vehicles, said modular unit comprising:
a first module which has at least one actuating unit;
a second module which has at least one lock assembly;
a coupling member coupling the first module and the second module together in order to actuate a lock of the at least one lock assembly when the actuating unit of the first module is actuated in order to initiate the opening and/or closing procedure of the door; and
a connecting element arranged between the first module and the second module, wherein the connecting element maintains a distance between the modules relative to one another substantially constant when a force F acts on at least one of the modules.

2. The Modular unit according to claim 1, in which the first module includes a carrier receiving a locking cylinder and mounting the actuating unit.

3. The Modular unit according to claim 2, in which at least one of the carrier and the locking cylinder is surrounded at least partially by a covering element.

4. The Modular unit according to claim 1, in which the connecting element is fastened to at least one of the carrier and the covering element by at least one of a material connection, a positive connection, and a non-positive connection.

5. The Modular unit according to claim 1, in which the connecting element connects together the first module and the second module.

6. The Modular unit according to claim 1, in which the connecting element is configured in one piece with one of the carrier and the covering element.

7. The Modular unit according to claim 1, in which one of the carrier and the covering element has an opening in which the connecting element is mounted.

8. The Modular unit according to claim 1, in which the connecting element is fastened to the lock assembly.

9. The Modular unit according to claim 1, in which a housing of the lock assembly has an opening receiving the connecting element.

10. The Modular unit according to claim 1, in which the connecting element is a supporting bar.

11. The Modular unit according to claim 1, in which the coupling member is one of a Bowden cable and a bar.
